(19) United States
(12) Patent Application Publication
(10) Pub. No.: US 2014/0049946 A1
(43) Pub. Date: Feb. 20, 2014

(54) ILLUMINATED BRACELET WITH SIDE LOCK CLOSURE

(71) Applicant: Jeffrey D. Schrimmer, Highland Park, IL (US)

(72) Inventor: Jeffrey D. Schrimmer, Highland Park, IL (US)

(73) Assignee: I PEE HOLDING LLC, Vernon Hills, IL (US)

(21) Appl. No.: 13/588,835

(22) Filed: Aug. 17, 2012

(51) Int. Cl. F21V 33/00

(52) U.S. Cl. CPC F21V 33/0008
USPC 362/103

(57) ABSTRACT

An illuminated novelty device is constructed as a banded ornament for wearing on a wrist, ankle and the like. The device includes a body having an upper surface and a side adjacent to the upper surface. The body has a fixed mounting end and a coupling portion and is formed from a translucent material. An illuminating assembly includes an illuminating element such that light is visible through the body material. A band for encircling a portion of a wearer's body has an upper surface, a fixed mounting portion and a coupling portion. The coupling portion is inserted into the body such that the body and band upper surfaces are flush with one another. The band and body mate to secure the device around the wearer's body and prevent longitudinal separation of the coupling portions.

### BACKGROUND

This disclosure pertains to an illuminated bracelet. More particularly, the disclosure pertains to an illuminated bracelet with a side lock closure.

Novelty illuminated bracelets are known in the art. Many such bracelets slip on a user's wrist, or include elastic to allow the bracelet to stretch, or include top-surface closures that can catch on clothing and the like.

Unlike some jewelry bracelets that are slim or low profile, illuminated bracelets typically have considerable thickness in order to contain the lighting element or elements and any power source, controls and the like that may be needed.

As such, in addition to the thickness of the bracelet, any secure, positive locking closure can result in a bracelet that is too thick or bulky to be attractively or comfortably worn.

Accordingly, there is a need for an illuminated bracelet with a reduced thickness. Desirably, such a bracelet includes a closure that does not add to the thickness or bulk of the bracelet. More desirably, such a bracelet closure is aesthetically acceptable. Still more desirably, such a bracelet closure does not detract from the illuminating effects and aesthetics of the bracelet.

### BRIEF SUMMARY

An illuminated novelty device is constructed as a banded ornament for wearing on a wrist, ankle and the like. In an embodiment, the device is configured and sized for a wearer's wrist. The device includes a body having an upper surface and a side adjacent to the upper surface. The body includes a fixed mounting end and a coupling portion. The body is formed, at least in part, from a translucent material.

An illuminating assembly is disposed, at least in part, in the body. The illuminating assembly includes at least one illuminating element such that light from the illuminating element, when illuminated, is visible through the body translucent material.

In a present device, the illuminating assembly includes a power source, such as one or more batteries, a switch and one or more lighting elements, such as LEDs. A control circuit can be configured to provide multiple lighting scenarios.

The device includes a band for encircling the portion of a wearer's body. The band has an upper surface, a fixed mounting portion mounted to the body fixed mounting portion and a coupling portion coupleable to the body coupling portion.

The band coupling portion is inserted into the body coupling portion at a side entrance of the body such that the body upper surface and band upper surface are flush with one another. The coupling portions mate with one another to secure the device around the wearer's body and prevent longitudinal separation of the coupling portions.

The coupling portions can include interlocking recesses and projections. In this arrangement, a projection on the body coupling portion inserts into a recess in the band coupling portion, and a projection on the band coupling portion inserts into a recess in the body coupling portion. The coupling portions can include necked-down portions adjacent respective projections and recesses such that the projections and recesses engage one another to secure the coupling portions to one another.

In an embodiment, the body coupling portion is defined, in part, by a wall opposite the body side entrance, and the body coupling portion includes inwardly extending projections disposed between the side entrance and the wall that define a stop for the band coupling portion.

The band can be formed from a light transmissive and/or translucent material.

These and other features and advantages of the present invention will be apparent from the following detailed description, in conjunction with the appended claims.

### BRIEF DESCRIPTION OF DRAWINGS

The benefits and advantages of the present invention will become more readily apparent to those of ordinary skill in the relevant art after reviewing the following detailed description and accompanying drawings and photographs, wherein:

FIG. 1 is a perspective view of an illuminated bracelet with a side lock closure;

FIG. 2 is a top view of the bracelet;

FIG. 3 is a front view of the bracelet;

FIG. 4 is a side view of the bracelet as seen from the left-hand side of FIG. 3;

FIG. 5 is a side view of the bracelet as seen from the right-hand side of FIG. 3;

FIG. 6 is a rear view of the bracelet;

FIG. 7 is a cross-sectional view taken along line 7-7 of FIG. 5;

FIG. 8 is a top perspective view of the bracelet with side lock closure open;

FIG. 9 is a bottom perspective view of the bracelet with side lock closure open;

FIG. 10 illustrates the insertion of the mating clasp portions;

FIG. 11 is a cross-sectional view taken along line 11-11 of FIG. 10;

FIG. 12 is a partially exploded view of the body portion of the bracelet, showing the end connection of the wristband portion;

FIG. 13 is an enlarged, partial, exploded view of the end connection and wristband portion;

FIG. 14 is an enlarged, partial, assembled view of the end connection and wristband portion; and

FIG. 15 is a cross-section view taken along line 15-15 of FIG. 14.

### DETAILED DESCRIPTION

While the present device is susceptible of embodiment in various forms, there is shown in the drawings and will hereinafter be described one or more presently preferred embodiments with the understanding that the present disclosure is to be considered an exemplification of the device and is not intended to limit the disclosure to the specific embodiment or embodiments illustrated.

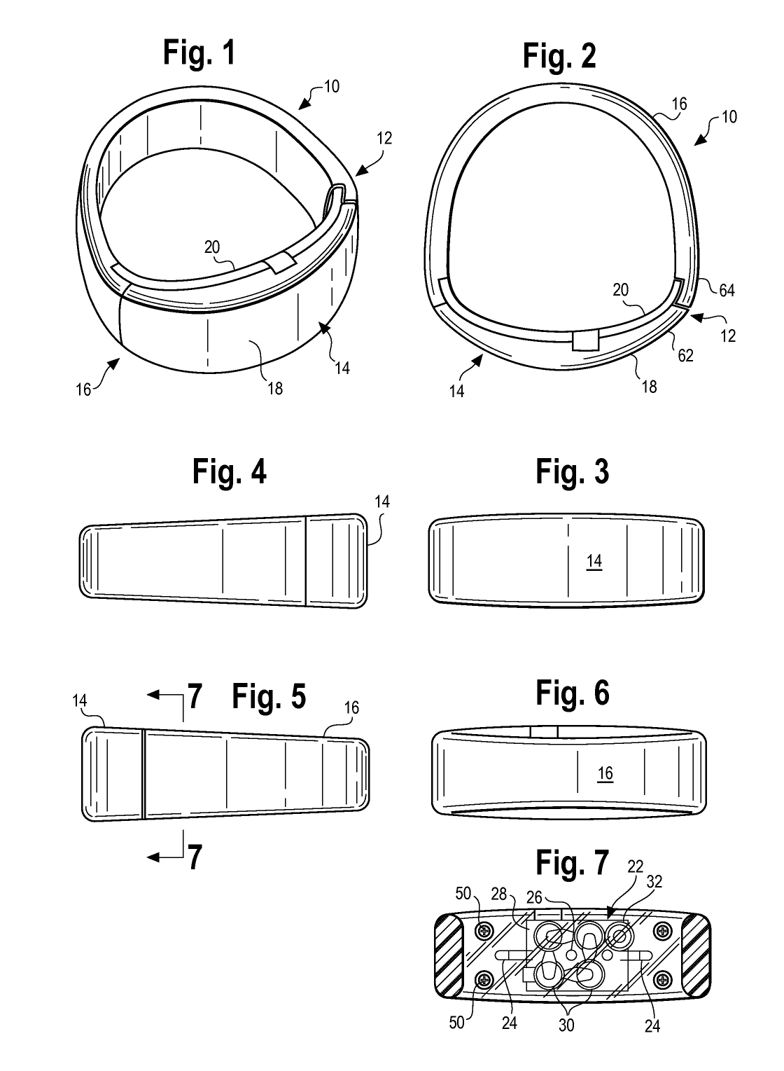

Referring now to the figures and in particular to FIG. 1 there is shown an embodiment of an illuminated novelty device 10 configured as a bracelet, with a side lock closure 12. The bracelet 10 includes, generally, a body portion 14 and a wristband portion 16. The body portion 14 includes a front faceplate 18, a rear enclosure 20 and an illuminating assembly 22. The illuminating assembly 22 can include one or more lights, such as the illustrated LEDs 24, a controller 26 which can be mounted to an integrated circuit board 28, a power supply 30, such as the illustrated batteries, and a switch 32. The switch 32 is used to control power supply to the controller 26 and LEDs 24 to illuminate the LEDs 24. Other light sources, circuitry and the like can be used, as will be recognized by those skilled in the art. In a present embodiment, the body portion 14 is formed from a clear or translucent material to permit light (from the LEDs 24) to pass through the body portion 14 so as to be visible external of the bracelet 10. It will also be appreciated by those skilled in the art that the body portion 14 has a relatively large thickness (relative to the wristband portion 16) to accommodate the illuminating assembly 22.

In a present bracelet 10, the controller 26 is configured to provide multiple lighting schemes. For example, the controller 26 can be configured to illuminate the LEDs 24 in a visually steady lighting scheme, a slow blinking lighting scheme, a fast lighting scheme, a random blinking lighting scheme, sequential lighting schemes (when two or more LEDs 24 are used), and the like.

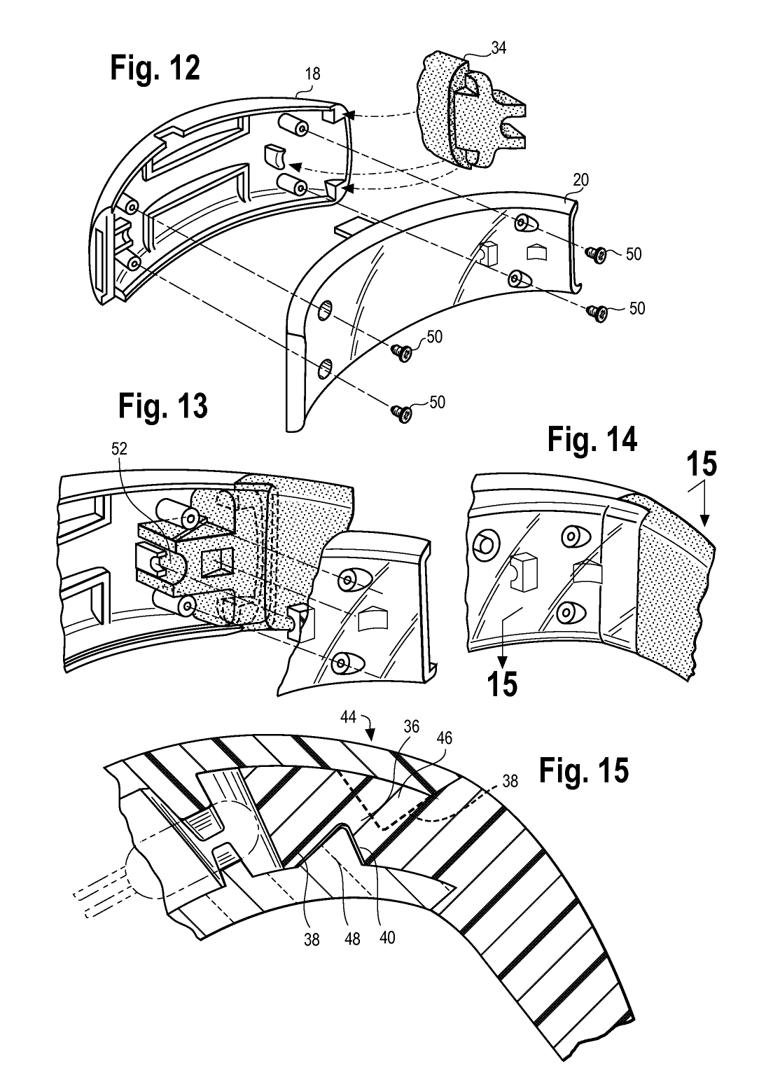

As seen in FIGS. 12-15, one end 34 of the wristband 16 is fixedly anchored to the body portion 14. The wristband 16 includes a multi-angled transition portion 36 that terminates at an enlarged, barbed end 38. The multi-angled portion 36 defines two recesses 40, 42. The body portion 14, at the joint 44, includes two projections 46, 48 that mate with the recesses 40, 42 to lock the wristband fixed end 34 in place in the body portion 14. Fasteners 50 , such as screws, rivets or the like, are used to secure rear enclosure 20 to the faceplate 18 with the wristband end 34 captured between the enclosure 20 and faceplate 18. As seen in FIG. 15, the wristband 16 can include a dimple or recess 52 in which a lighting element, such as the illustrated LED 24, can be positioned. The rear enclosure 20 may be removable so that the power source, e.g., battery 30, can be replaced as needed. Alternately, the rear enclosure can be sealed.

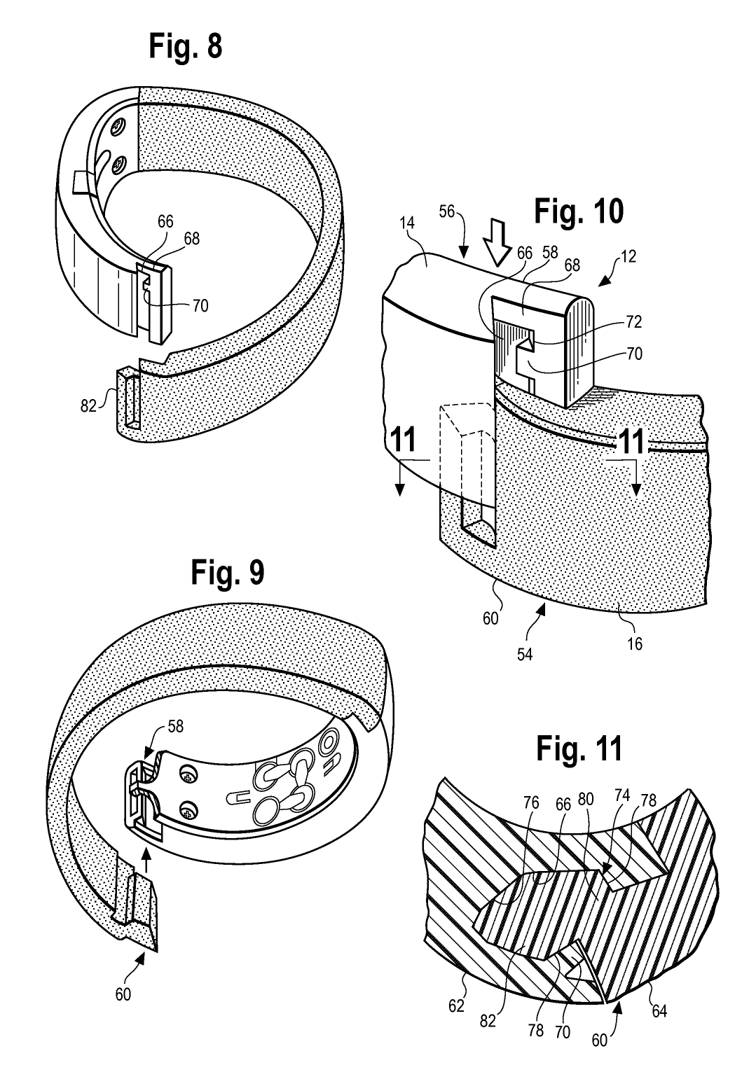

The opposing ends 54, 56 of the wristband 16 and body 14 have a side lock closure 12 that includes mating coupling portions 58, 60 to permit readily putting on and taking off the bracelet 10. As can be seen in FIGS. 1-2 and 8-11, the mating portions 58, 60, when joined together, lie flush with the wristband 16 and body 14, and the upper surfaces 62, 64 of the body 14 and wristband 16 are flush with one another, and do not detract from the smooth lines and aesthetic of the bracelet 10. Accordingly, the body portion coupling 58 includes a receiver 66 formed as a cavity at the end thereof, transverse to the longitudinal extent of the body portion 14. The cavity 66 extends to, but not through an outer wall 68 of the body portion end 56. Projections 70 (one shown) extend inwardly from a rear wall 72 of the end 56, into the cavity 66, and serves as a detent or stop.

The cavity 66 defines a necked-down region 74, which, along with the adjacent, larger region 76, defines a locking portion. The necked-down portion 74 includes multi-angled walls 78.

The wristband coupling portion 60 includes a necked-down portion 80 that fits into and mates with the cavity necked-down portion 74, and an enlarged head 82. The enlarged head 82 is configured to fit into and mate with the cavity 66. The head 82 and the necked-down portion 80 are sized, shaped and configured to fit within the cavity necked-down portion 74 and locking region 76 and flush with the inner walls thereof.

The wristband coupling portion head 82 extends only a portion of the transverse width of the wristband 16. In this manner, the head 82, when in place in the cavity 66 projections 70. This prevents the head from being inserted into one side of the cavity and out the other side (since the other side, or outer wall 68 side, is closed). It will be appreciated that this configuration prevents the wristband portion 60 from being pulled or longitudinally removed from the body portion 58, and permits only a sideways sliding movement for installation for putting on and taking off the bracelet 10.

In a present bracelet 10, the wristband 16 is formed from a soft, resilient, light-transmissive material. Such a material permits the transmission of light to increase the pleasing luminescent effects of the bracelet 10. When in use, the material appears to glow, particularly at the transitions of the wristband 16 and the body portion 14. It will, however, be understood that the wristband 16 can be formed of most any resilient material whether light-transmissive or not. The bracelet 10 may also be formed with light creating or light transmitting materials therein, such as chemiluminescent materials, fiber optic elements and the like, to further enhance the illuminating effects of the bracelet 10.

It will also be appreciated that although the present illuminated bracelet 10 is referred to as a bracelet and disclosed with respect to being worn on a user's wrist, the present illuminated device 10 can be sized and configured as an anklet, a necklace or for wearing on any other part of the wearer's body, and that such configurations are within the scope and spirit of the present disclosure.

All patents referred to herein, are incorporated herein by reference, whether or not specifically done so within the text of this disclosure. In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present disclosure. It is to be understood that no limitation with respect to the specific embodiments illustrated is intended or should be inferred. The disclosure is intended to cover by the appended claims all such modifications as fall within the scope of the claims.

What is claimed is:

1. An illuminated novelty device, comprising:
a body having an upper surface and a side adjacent to the upper surface, the body including a fixed mounting end and a coupling portion, the body formed, at least in part, from a translucent material;
an illuminating assembly disposed, at least in part, in the body, the illuminating assembly including at least one illuminating element such that light from the illuminating element, when illuminated, is visible through the body translucent material;
a band for encircling a portion of a wearer's body, the band having an upper surface, a fixed mounting portion mounted to the body fixed mounting portion and a coupling portion coupled to the body coupling portion,
wherein the band coupling portion is inserted into the body coupling portion at a side entrance of the body such that the body upper surface and band upper surface are flush with one another, the band coupling portion and the body coupling portion mating with one another to secure the illuminated novelty device around a portion of a wearer's body and to prevent longitudinal removal of the band coupling portion from the body coupling portion.

2. The illuminated novelty device of claim 1 wherein the device is sized and configured to fit on the wearer's wrist.

3. The illuminated novelty device of claim 1 wherein the body coupling portion and the band coupling portion include interlocking recesses and projections, a projection on the body coupling portion inserting into a recess in the band coupling portion, and a projection on the band coupling portion inserting into a recess in the body coupling portion.

4. The illuminated novelty device of claim 3 wherein the body coupling portion and the band coupling portion include necked-down portions adjacent the respective projections and recesses and wherein the respective projections and recesses engage one another to secure the body coupling portion and band coupling portion to one another.

5. The illuminated novelty device of claim 4 wherein the body coupling portion is defined, in part, by a wall opposite the body side entrance

6. The illuminated novelty device of claim 5, wherein the body coupling portion includes inwardly extending projections disposed between the side entrance and the wall defining a stop for the band coupling portion.

7. The illuminated novelty device of claim 1 wherein the illuminating assembly includes a power source, a switch and one or more lighting elements.

8. The illuminated novelty device of claim 7 wherein the one or more lighting elements are LEDs.

9. The illuminated novelty device of claim 7 wherein the power source is one or more batteries.

10. The illuminated novelty device of claim 7 including a control circuit, the control circuit configured to provide multiple lighting scenarios.

11. The illuminated novelty device of claim 1 wherein the band is formed from a light transmissive material.

12. The illuminated novelty device of claim 1 wherein the band is formed form a translucent material.
